(19) United States
(12) Patent Application Publication
(10) Pub. No.: US 2022/0127427 A1
(43) Pub. Date: Apr. 28, 2022

(54) METHOD FOR PRODUCING POLYIMIDE FILM

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Tzu-Huan Wong, Hualien County (TW)

(21) Appl. No.: 17/380,021

(22) Filed: Jul. 20, 2021

(30) Foreign Application Priority Data
Oct. 26, 2020 (TW) 109137023

(51) Int. Cl. C08J 5/18; C08G 73/10; B29C 41/00; B29C 41/46

(52) U.S. Cl. CPC C08J 5/18; C08G 73/1078; C08G 73/1007; B29K 2079/08; B29C 41/46; C08J 2379/08; B29C 41/003

(57) ABSTRACT

A method for producing a polyimide film includes: providing a polyimide coating solution; providing a high temperature resistant polyester substrate; and coating the polyimide coating solution on the high temperature resistant polyester substrate, so that a polyimide wet coating is formed on the high temperature resistant polyester substrate; implementing a first baking step, which includes: baking the polyimide wet coating at a first temperature of between 60° C. and 130° C. to remove a part of organic solvent in the polyimide wet coating; implementing a second baking step, which includes: baking the polyimide wet coating at a second temperature of between 140° C. and 220° C. to remove a residual part of the organic solvent in the polyimide wet coating, so as to form the polyimide film on the high temperature resistant polyester substrate; and separating the polyimide film and the high temperature resistant polyester substrate from each other.

### CROSS-REFERENCE TO RELATED PATENT APPLICATION

This application claims the benefit of priority to Taiwan Patent Application No. 109137023, filed on Oct. 26, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for producing a polymer film, and more particularly to a method for producing a polyimide film.

### BACKGROUND OF THE DISCLOSURE

In the technical field of displays, the technical development of flexible displays and foldable displays has drawn more and more attention. The cover window film of a general conventional display, such as a general liquid crystal display, is usually a glass film. However, the glass film is not flexible, which is not suitable for use as a cover window film for a flexible or foldable display.

Compared with the glass film, a polyimide film has high transparency, low haze, and better flexibility. The polyimide film is regarded as one of the key materials for flexible displays and foldable displays. The polyimide film, as a material to replace the glass film, needs to have high hardness. In order to enable the polyimide film to have the characteristics of high hardness, a processing method in the conventional technique mainly coats a surface of the polyimide film with a higher hardness coating, such as an acrylic resin or an epoxy resin, to increase an overall hardness of the polyimide film. However, since the hardness of the polyimide film itself is low, the hard coating layer tends to cause warping on the surface of the polyimide film. Furthermore, since the hard coating layer has poor flexibility, the hard coating layer is prone to crack when being bent.

### SUMMARY OF THE DISCLOSURE

In response to the above-referenced technical inadequacies, the present disclosure provides a method for producing a polyimide film.

In one aspect, the present disclosure provides a method for producing a polyimide film, including: providing a polyimide coating solution, which includes: an organic solvent, a polyimide resin, and inorganic nanoparticles; in which the polyimide resin and the inorganic nanoparticles are dispersed in the organic solvent; providing a high temperature resistant polyester substrate, which includes: a polyester resin and a high temperature resistant resin dispersed in the polyester resin; coating the polyimide coating solution on the high temperature resistant polyester substrate to form a polyimide wet coating on the high temperature resistant polyester substrate; implementing a first baking step, which includes: baking the polyimide wet coating at a first temperature of between 60° C. and 130° C. to remove a part of the organic solvent in the polyimide wet coating; implementing a second baking step, which includes: baking the polyimide wet coating at a second temperature of between 140° C. and 220° C. to remove a residual part of the organic solvent in the polyimide wet coating, thereby forming the polyimide film on the high temperature resistant polyester substrate; and separating the polyimide film and the high temperature resistant polyester substrate from each other.

Preferably, in the polyimide coating solution, the organic solvent is at least one material selected from a group consisting of γ-butyrolactone (GBL), tetrahydrofuran (THF), N,N-dimethylacetamide (DMAc), hexamethyl phosphamide (HMPA), N-methyl-2-pyrrolidone (NMP), and 1,3-dimethyl-imidazolinone (DMI).

Preferably, the polyimide resin is formed by a poly-condensation reaction between an aromatic diamine monomer and an alicyclic dianhydride monomer.

Preferably, the inorganic nanoparticles are at least one material selected from a group consisting of metal oxide, silicon oxide, and sulfide, and the inorganic nanoparticles have an average particle size of between 20 nanometers and 120 nanometers.

Preferably, the metal oxide is at least one material selected from a group consisting of calcium oxide (CaO), zinc oxide (ZnO), titanium dioxide (TiO₂), zirconium dioxide (ZrO₂), tin dioxide (SnO₂), aluminum oxide (Al₂O₃), and indium oxide (In₂O₃). The silicon oxide is silicon dioxide (SiO₂), and the sulfide is barium sulfate (BaSO₄).

Preferably, based on a total weight of the polyimide coating solution being 100 wt %, a sum of weight percent concentrations of the polyimide resin and the inorganic nanoparticles is between 10 wt % and 30 wt %, and a weight percent concentration of the organic solvent is between 70 wt % and 90 wt %.

Preferably, in the polyimide coating solution, a weight ratio of the polyimide resin relative to the inorganic nanoparticles ranges between 95:5 and 50:50.

Preferably, in the high temperature resistant polyester substrate, the high temperature resistant resin is dispersed in the polyester resin with an average particle size of between 50 nanometers and 200 nanometers, and a content range of the high temperature resistant resin in the high temperature resistant polyester substrate is between 10 wt % and 50 wt %.

Preferably, the high temperature resistant resin has a glass transition temperature, a melting point, or a heat distortion temperature of between 180° C. and 400° C.; in which the high temperature resistant resin is at least one material selected from a group consisting of polyether imide (PEI), poly sulfone (PSU), liquid crystal polymer (LCP), polyether ether ketone (PEEK), and polyamide imide (PAI).

Preferably, the polyimide film has a pencil hardness of between 1H and 2H, a transparency of between 88% and 92%, a haze value of between 0.3% and 1.5%, a tensile strength of between 80 MPa and 125 MPa, and a coefficient of thermal expansion (CTE) of between 10 ppm/° C. and 40 ppm/° C.

Therefore, by virtue of “the material selections of the polyimide coating solution”, “the material selections of the high temperature resistant polyester substrate” and “the steps of coating the polyimide coating solution on the high temperature resistant polyester substrate to form the polyimide wet coating on the high temperature resistant polyester substrate; implementing the first baking step, which includes: baking the polyimide wet coating at the first temperature of between 60° C. and 130° C. to remove a part of the organic solvent in the polyimide wet coating; implementing the second baking step, which includes: baking the polyimide wet coating at the second temperature of between 140° C. and 220° C. to remove a residual part of the organic solvent in the polyimide wet coating, thereby forming the polyimide film on the high temperature resistant polyester substrate; and separating the polyimide film and the high temperature resistant polyester substrate from each other”, the polyimide film provided by the present disclosure does not need to be separated from the high temperature resistant polyester substrate in the first and second baking steps, so that the process yield of the polyimide film can be effectively improved, and the manufacturing cost of the polyimide film can be effectively reduced.

Furthermore, since the polyimide coating solution of the present embodiment includes the inorganic nanoparticles dispersed therein, mechanical properties, such as pencil hardness and tensile strength, of the final product of the method for producing polyimide film can be improved, and optical properties, such as transparency and haze value of the polyimide film can be maintained at desired levels.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic flow chart of a method for producing a polyimide film according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Method for Producing Polyimide Film

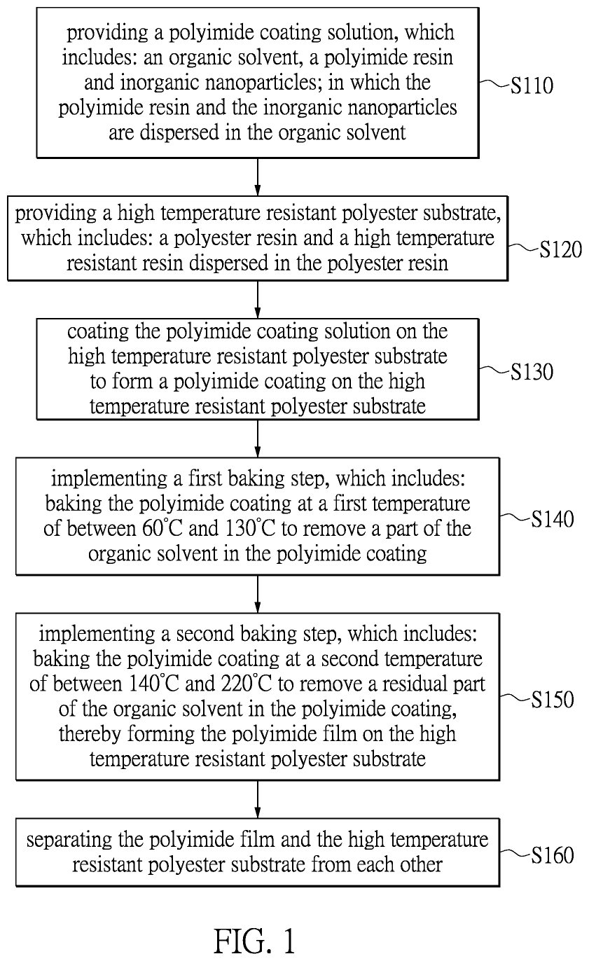

As shown in FIG. 1, an embodiment of the present disclosure discloses a method for producing a polyimide film. The method for producing the polyimide film includes steps of S110, S120, S130, S140, S150, and S160. It should be noted that the sequence of the steps and the actual way of operation described in the present embodiment can be adjusted according to requirements and are not limited to those described in the present embodiment.

The step S110 includes: providing a polyimide coating solution. The polyimide coating solution includes: an organic solvent, a polyimide resin, and inorganic nanoparticles. The polyimide resin and the inorganic nanoparticles are dispersed in the organic solvent.

In various embodiments of the present disclosure, the organic solvent is at least one material selected from a group consisting of γ-butyrolactone (GBL), tetrahydrofuran (THF), N,N-dimethylacetamide (DMAc), hexamethyl phosphamide (HMPA), N-methyl-2-pyrrolidone (NMP), and 1,3-dimethyl-imidazolinone (DMI). Accordingly, the polyimide resin and the inorganic nanoparticles can be uniformly dispersed in the organic solvent through the material selections of the organic solvent.

In various embodiments of the present disclosure, the polyimide resin is formed by a poly-condensation reaction between an aromatic diamine monomer and an alicyclic dianhydride monomer. Since the aromatic diamine monomer has a plurality of benzene rings in its molecular structure, the polyimide resin enables the finally produced polyimide film to have better hardness and rigidity without sacrificing flexibility.

In various embodiments of the present disclosure, the inorganic nanoparticles are at least one material selected from a group consisting of metal oxide, silicon oxide, and sulfide. In addition, the inorganic nanoparticles have an average particle size of between 20 nanometers and 120 nanometers, but the present disclosure is not limited thereto. The inorganic nanoparticles that are added enable the hardness of the finally produced polyimide film to be effectively improved.

Furthermore, the metal oxide is at least one material selected from a group consisting of calcium oxide (CaO), zinc oxide (ZnO), titanium dioxide (TiO₂), zirconium dioxide (ZrO₂), tin dioxide (SnO₂), aluminum oxide (Al₂O₃), and indium oxide (In₂O₃). In addition, the silicon oxide is silicon dioxide (SiO₂), and the sulfide is barium sulfate.

To enable the polyimide coating solution to have good coating and film-forming characteristics, the components in the polyimide coating solution have a specific weight ratio range.

Based on a total weight of the polyimide coating solution being 100 wt %, a sum of weight percent concentrations of the polyimide resin and the inorganic nanoparticles is between 10 wt % and 30 wt %, and a weight percent concentration of the organic solvent is between 70 wt % and 90 wt %.

That is, in the polyimide coating solution, a content of the organic solvent is between 70 wt % and 90 wt %, and a content of the remaining solid components, such as the polyimide resin and the inorganic nanoparticles, is between 10 wt % and 30 wt %.

Furthermore, in the polyimide coating solution, a weight ratio of the polyimide resin relative to the inorganic nanoparticles preferably ranges between 95:5 and 50:50, and more preferably between 95:5 and 70:30, but the present disclosure is not limited thereto.

In the present embodiment, the polyimide coating solution is in a liquid state and has fluid properties. The polyimide coating solution of the present embodiment has a viscosity of between 4,000 cps and 10,000 cps, and preferably between 5,000 cps and 9,000 cps, according to the above-mentioned content range, so that the polyimide coating solution can be easily coated on a substrate by a coating method, such as slit coating or knife coating.

If the content range of each component in the polyimide coating solution exceeds the above-defined range, the viscosity of the polyimide coating solution may become too diluted or too thick, so that the polyimide coating solution is not easy to be coated on the substrate. In other words, the polyimide coating solution may not have the good coating and film-forming characteristics.

The step S120 includes: providing a high temperature resistant polyester substrate. The high temperature resistant polyester substrate includes: a polyester resin and a high temperature resistant resin dispersed in the polyester resin.

In the high temperature resistant polyester substrate, the high temperature resistant resin is dispersed in the polyester resin with an average particle size of between 50 nanometers and 200 nanometers. In addition, a content range of the high temperature resistant resin in the high temperature resistant polyester substrate is preferably between 10 wt % and 50 wt %, and more preferably between 15 wt % and 50 wt %.

To enable the high temperature resistant polyester substrate to have the characteristics of high temperature resistance and bending resistance, the high temperature resistant resin is at least one material selected from a group consisting of polyether imide (PEI), poly sulfone (PSU), liquid crystal polymer (LCP), polyether ether ketone (PEEK), and polyamide imide (PAI).

Among the above-mentioned high temperature resistant resin materials, the polyether imide (PEI) is a non-crystalline resin material and has a glass transition temperature of approximately 215° C. The poly sulfone (PSU) is an amorphous resin material and has a glass transition temperature of approximately 185° C. and a melting point of approximately 280° C. The liquid crystal polymer (LCP) is a crystalline resin material and has a heat distortion temperature of between 180° C. and 260° C. The polyether ether ketone (PEEK) is a semi-crystalline resin material and has a glass transition temperature of approximately 340° C. The polyamide imide (PAI) is a non-crystalline resin material and has a glass transition temperature of between 280° C. and 290° C.

In other words, the above-mentioned high temperature resistant resin material may be, for example, a crystalline resin material, a semi-crystalline resin material, or an amorphous resin material, and the high temperature resistant resin material may, for example, have a glass transition temperature, a melting point, or a heat distortion temperature of between 180° C. and 400° C.

Furthermore, the polyester resin is a polymer obtained by a condensation polymerization reaction of a dibasic acid and a diol or its derivatives. Preferably, the polyester resin is polyethylene terephthalate (PET) or polyethylene naphthalate (PEN), but the present disclosure is not limited thereto.

In the present embodiment, the overall thickness of the high temperature resistant polyester substrate is between 15 micrometers and 350 micrometers, but the present disclosure is not limited thereto.

The step S130 includes: coating the polyimide coating solution on the high temperature resistant polyester substrate to form a polyimide wet coating (also called a polyimide wet film) on the high temperature resistant polyester substrate.

The polyimide coating solution can be coated on the high temperature resistant polyester substrate via a knife coating manner to form the polyimide wet coating. Furthermore, the polyimide wet coating can have a thickness of between 100 micrometers and 500 micrometers, but the present disclosure is not limited thereto.

It is worth mentioning that, in the step S130, the components of the polyimide wet coating include: the organic solvent, the polyimide resin, and the inorganic nanoparticles. The organic solvent will be removed in the subsequent baking steps, so that the polyimide wet coating is formed into a polyimide film (also called a polyimide dry film) That is, the main components of the polyimide film are the polyimide resin and the inorganic nanoparticles dispersed in the polyimide resin.

The step S140 includes: implementing a first baking step. The first baking step includes: baking the polyimide wet coating at a first temperature of between 60° C. and 130° C. to remove a part of the organic solvent in the polyimide wet coating. In this step, the polyimide wet coating can be roughly formed on the high temperature resistant polyester substrate, however, residual organic solvent in the polyimide wet coating needs to be removed.

In addition, a baking time of the first baking step is preferably between 10 minutes and 45 minutes, and more preferably between 15 minutes and 30 minutes, but the present disclosure is not limited thereto.

The step 150 includes: implementing a second baking step. The second baking step includes: baking the polyimide wet coating at a second temperature of between 140° C. and 220° C. to remove the residual part of the organic solvent in the polyimide wet coating, thereby forming the polyimide film (also called a polyimide dry film) on the high temperature resistant polyester substrate.

In addition, a baking time of the second baking step is preferably between 10 minutes and 45 minutes, and more preferably between 15 minutes and 30 minutes, but the present disclosure is not limited thereto.

The step 160 includes: separating the polyimide film and the high temperature resistant polyester substrate from each other to complete the preparation of the polyimide film. The overall thickness of the polyimide film is between 15 micrometers and 70 micrometers, and preferably between 25 micrometers and 60 micrometers, but the present disclosure is not limited thereto.

According to the above configuration, the polyimide film has a pencil hardness of between 1H and 2H, a transparency of between 88% and 92%, a haze value of between 0.3% and 1.5%, a tensile strength of between 80 MPa and 125 MPa, and a coefficient of thermal expansion (CTE) of between 10 ppm/° C. and 40 ppm/° C.

It is worth mentioning that, in the present embodiment, the polyimide film is closely attached to the high temperature resistant polyester substrate in the first baking step S140 and the second baking step S150. That is, the polyimide film is not separated from the high temperature resistant polyester substrate in the above two baking steps.

More specifically, since the polyester substrate of the present embodiment is a high temperature resistant polyester substrate that can withstand high temperatures ranging from 140° C. to 220° C., the high temperature resistant polyester substrate will not warp in the second baking step. Accordingly, the polyimide film does not need to be separated from the high temperature resistant polyester substrate in the above two baking steps, so that the process yield of the polyimide film can be effectively improved, and the manufacturing cost of the polyimide film can be effectively reduced.

In addition, since the coated substrate selected in the present embodiment is a polyester substrate, the polyimide film can be flexed during the manufacturing process, for example, through a roll-to-roll process. Therefore, the processability of the polyimide film during the manufacturing process can be effectively improved.

Furthermore, since the polyimide coating solution of the present embodiment includes the inorganic nanoparticles dispersed therein, the mechanical properties, such as the pencil hardness and the tensile strength, of the finally produced polyimide film can be improved, and the optical properties, such as the transparency and the haze value of the polyimide film cannot be affected. The polyimide film will not warp during the manufacturing process.

### Beneficial Effects of the Embodiments

In conclusion, by virtue of “the material selections of the polyimide coating solution”, “the material selections of the high temperature resistant polyester substrate” and “the steps of coating the polyimide coating solution on the high temperature resistant polyester substrate to form the polyimide wet coating on the high temperature resistant polyester substrate; implementing the first baking step, which includes: baking the polyimide wet coating at the first temperature of between 60° C. and 130° C. to remove a part of the organic solvent in the polyimide wet coating; implementing the second baking step, which includes: baking the polyimide wet coating at the second temperature of between 140° C. and 220° C. to remove a residual part of the organic solvent in the polyimide wet coating, thereby forming the polyimide film on the high temperature resistant polyester substrate; and separating the polyimide film and the high temperature resistant polyester substrate from each other”, the polyimide film provided by the present disclosure does not need to be separated from the high temperature resistant polyester substrate in the first and second baking steps, so that the process yield of the polyimide film can be effectively improved, and the manufacturing cost of the polyimide film can be effectively reduced.

Furthermore, since the polyimide coating solution of the present embodiment includes the inorganic nanoparticles dispersed therein, the mechanical properties, such as pencil hardness and tensile strength, of the final product of the method for producing polyimide film can be improved, and the optical properties, such as transparency and haze value of the polyimide film can be maintained at desired levels.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing a polyimide film, comprising:
providing a polyimide coating solution, which includes: an organic solvent, a polyimide resin, and inorganic nanoparticles; wherein the polyimide resin and the inorganic nanoparticles are dispersed in the organic solvent;
providing a high temperature resistant polyester substrate, which includes: a polyester resin and a high temperature resistant resin dispersed in the polyester resin;
coating the polyimide coating solution on the high temperature resistant polyester substrate to form a polyimide wet coating on the high temperature resistant polyester substrate;
implementing a first baking step, which includes: baking the polyimide wet coating at a first temperature of between 60° C. and 130° C. to remove a part of the organic solvent in the polyimide wet coating;
implementing a second baking step, which includes: baking the polyimide wet coating at a second temperature of between 140° C. and 220° C. to remove a residual part of the organic solvent in the polyimide wet coating, so as to form the polyimide film on the high temperature resistant polyester substrate; and
separating the polyimide film and the high temperature resistant polyester substrate from each other.

2. The method for producing the polyimide film according to claim 1, wherein, in the polyimide coating solution, the organic solvent is at least one material selected from a group consisting of γ-butyrolactone (GBL), tetrahydrofuran (THF), N,N-dimethylacetamide (DMAc), hexamethyl phosphamide (HMPA), N-methyl-2-pyrrolidone (NMP), and 1,3-dimethyl-imidazolinone (DMI).

3. The method for producing the polyimide film according to claim 2, wherein the polyimide resin is formed by a poly-condensation reaction between an aromatic diamine monomer and an alicyclic dianhydride monomer.

4. The method for producing the polyimide film according to claim 3, wherein the inorganic nanoparticles are at least one material selected from a group consisting of metal oxide, silicon oxide, and sulfide, and the inorganic nanoparticles have an average particle size of between 20 nanometers and 120 nanometers.

5. The method for producing the polyimide film according to claim 4, wherein the metal oxide is at least one material selected from a group consisting of calcium oxide (CaO), zinc oxide (ZnO), titanium dioxide (TiO₂), zirconium dioxide (ZrO₂), tin dioxide (SnO₂), aluminum oxide (Al₂O₃), and indium oxide (In₂O₃); wherein the silicon oxide is silicon dioxide (SiO₂), and the sulfide is barium sulfate (BaSO₄).

6. The method for producing the polyimide film according to claim 5, wherein, based on a total weight of the polyimide coating solution being 100 wt %, a sum of weight percent concentrations of the polyimide resin and the inorganic nanoparticles is between 10 wt % and 30 wt %, and a weight percent concentration of the organic solvent is between 70 wt % and 90 wt %.

7. The method for producing the polyimide film according to claim 6, wherein, in the polyimide coating solution, a weight ratio of the polyimide resin relative to the inorganic nanoparticles ranges between 95:5 and 50:50.

8. The method for producing the polyimide film according to claim 1, wherein, in the high temperature resistant polyester substrate, the high temperature resistant resin is dispersed in the polyester resin with an average particle size of between 50 nanometers and 200 nanometers, and a content range of the high temperature resistant resin in the high temperature resistant polyester substrate is between 10 wt % and 50 wt %.

9. The method for producing the polyimide film according to claim 8, wherein the high temperature resistant resin has a glass transition temperature, a melting point, or a heat distortion temperature of between 180° C. and 400° C.; wherein the high temperature resistant resin is at least one material selected from a group consisting of polyether imide (PEI), poly sulfone (PSU), liquid crystal polymer (LCP), polyether ether ketone (PEEK), and polyamide imide (PAI).

10. The method for producing the polyimide film according to claim 1, wherein the polyimide film has a pencil hardness of between 1H and 2H, a transparency of between 88% and 92%, a haze value of between 0.3% and 1.5%, a tensile strength of between 80 MPa and 125 MPa, and a coefficient of thermal expansion (CTE) of between 10 ppm/° C. and 40 ppm/° C.
